(19) United States
(12) Patent Application Publication
(10) Pub. No.: US 2003/0152047 A1
(43) Pub. Date: Aug. 14, 2003

(54) Method for detecting travel information

(76) Inventor: Michael Alger, Muenchen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/312,776

(22) PCT Filed: Jun. 19, 2001
(86) PCT No.: PCT/DE01/02275

(30) Foreign Application Priority Data
Jun. 28, 2000 (DE) 10032800.8

(51) Int. Cl. H04Q 7/00

(52) U.S. Cl. 370/328; 370/350

(57) ABSTRACT

The invention relates to a method for detecting travel information in a traffic network covered by a cellular mobile radio network with a plurality of base stations provided with a clear identifier and wherein a plurality of vehicles move, said vehicles being respectively provided with an operating mobile terminal for the mobile radio network. Information on the contact between the end terminals and the base stations is used to estimate the location of the terminals. At least for one part of the traffic network, wherein the base stations have a transmission range with a cell radius corresponding to the distance separating neighboring traffic routes, characteristic models are determined in the form of sequences of identifiers of said base stations with which a terminal respectively enters into contact when it is displaced along a route, allocated to the respective route and permanently stored.

### DESCRIPTION

The invention relates to a method for acquiring traffic situation data in a network of traffic routes which is covered by a cellular mobile radio network having a large number of base stations, and in which a large number of vehicles move, each being provided with an operating mobile terminal for the mobile radio network, in particular a mobile telephone, information about the contact between the terminals and the base stations being used to estimate the current location of terminals.

Numerous methods of acquiring traffic situation data are known, in which this data is recorded by vehicles which, in the sense of a random sample vehicle fleet, participate in road traffic, and said data is reported onward to a central facility by means of mobile radio with information about the current vehicle position. The data transmitted to the central facility normally contains information relating to the position of the vehicle and its speed. In this case, the determination of the current vehicle position is carried out in the vehicle itself, for example by a navigation satellite system (eg. GPS) being used. Since reliable traffic location acquisition requires a large number of vehicles in the random sample vehicle fleet, the result is a considerable expenditure for carrying out the data traffic between the vehicles and the central facility. In order to limit this expenditure, it is known from EP 0 715 285 B1, for example, to provide the vehicles of the random sample vehicle fleet from the central facility with stipulations as to the conditions under which a data transmission from the vehicles to the central facility is to be performed at all, so that to a large extent a restriction of the data traffic to the occurrences of disruptions in the traffic flow can be made. Nevertheless, this method is not only associated with a considerable loading of the channels of the mobile radio network used, but also requires specific device fitting in the individual vehicles of the random sample vehicle fleet.

DE 198 36 178 A1 discloses a method for localizing mobile telephones in a mobile radio network by means of triangulation on the basis of signal propagation times between the mobile telephone and a plurality of base stations within whose transmission range the mobile telephone is located. In what are known as TDMA mobile radio systems, the propagation time of each radio connection between the mobile terminal and the base stations of the mobile radio network is determined for the purpose of adjusting the terminal synchronization, that is to say the phase of the TDMA frame at the terminal. Since the propagation time of the signal is representative of the distance between the terminal and the respective base station, in principle a very simple location determination can be carried out if the distances from a plurality of base stations are known. There is therefore a possibility of determining the current geographic position of the respective terminal relative to the known geographic positions of the base stations. The location can thus in principle be carried out even without the use of a GPS system, but the accuracy is generally lower because of the limited resolution (about 500 m). In conurbations in particular, owing to this limited accuracy, no unambiguous assignment between a mobile terminal which is located in a vehicle on a street and this street would be possible.

In DE 198 36 089 A1, a method of determining dynamic traffic information is described in which the base stations of a mobile radio network set up in a network of traffic routes estimate the respective distance to a mobile terminal on the basis of the signal intensity received and draw conclusions about movements of the mobile terminal via the change in the signal intensity. The resolution of this method is comparatively coarse and therefore less suitable in particular for traffic networks having a high density of traffic routes. However, in this method, the circumstance that no specific terminals have to be available in the individual vehicles is likewise advantageous, instead the presence of, for example, an operating mobile telephone in the vehicle is sufficient.

It is an object of the present invention to develop a method of the type mentioned at the beginning to the effect that, with the lowest possible expenditure, it permits adequately reliable acquisition of the traffic situation. In particular, the use of specific equipment which is aimed at the acquisition of traffic situation data shall not be required in the vehicles using the traffic routes. Furthermore, a device system for implementing this method is to be proposed.

This object is achieved by a method having the features specified in patent claim 1. Advantageous developments of this method emerge from the dependent subclaims. In order to implement this method, a device system as claimed in claim 14 is proposed.

The present invention begins from the fact that a network of traffic routes is covered by a cellular mobile radio network having a large number of base stations which each have a unique identifier. In this network of traffic routes there moves a large number of vehicles, which are each provided with an operating mobile terminal for the mobile radio network (eg. mobile telephone). In order to ensure the serviceability of the mobile terminals, these are in contact (radio contact) with individual base stations, depending on their current location. Information about these contacts is used by the terminals in order to estimate the current location (which can also mean a currently used route section). For this purpose, the invention provides that, at least for part of the network of traffic routes, in which the base stations have a transmission range with a cell radius which is of the order of magnitude of the distance between adjacent traffic routes to be distinguished from one another, characteristic patterns are determined in the sense of sequences of the identifiers of those base stations with which in each case a terminal makes contact as it moves along the course of a route, are assigned to the respective route and are permanently stored. In this way, the geometry of the respective route is likewise mapped onto a typical sequence of base station identifiers.

With regard to the terms transmission range and cell radius, it should be noted that these are in no way always circular transmission ranges. These can also have many other types of shapes, for example elliptical or lobe-shaped. Cell radius then in each case means the largest characteristic transverse dimension.

In order then to obtain current traffic information, the invention further provides for selected terminals within the respective range of the network of traffic routes to be tracked in detail, in that in each case the current sequence of base stations contacted in detail by a terminal is determined and compared with the stored characteristic patterns. By using this comparison, it is then possible to decide in which route the respective terminal is currently located. The question of the direction in which the terminal is moving along the identified route can easily be decided by using the order of the identifiers of the base stations. It is particularly advantageous if, in the current sequence of contacted base stations, in each case information about the time at which contact was made between the respective terminal and the respective base station is recorded and used to determine a value representative of the speed of movement of the respective terminal.

In principle, the hit accuracy, that is to say the resolution capacity of the method according to the invention, is better the smaller the individual cell radii. Use is preferably made of a mobile radio network which predominantly has cell radii of less than 1000 m, in particular less than 550 m. The still permissible size of the cell radii depends to a great extent on the density of the traffic routes in the region considered. The higher the density, the smaller should the cell radii be. In regions with large distances between the traffic routes, correspondingly large cell radii are permissible. In investigations on the German motorway network, it could be discovered that, for 60% of this network of traffic routes, even cell radii of up to 2 km in size were still permissible for an unambiguous assignment of the roads. In the case of cell radii of below 600 m, appropriate coverage of 95% of the German motorway network would be possible. It is obvious that the cell radii may differ greatly from one another in terms of their size, depending on the local conditions of the density of traffic routes, without endangering the success of the method according to the invention.

Since, with the increasing spread of mobile radio terminals in vehicles, the number of terminals registered overall in a specific zone correlates quite well with the actual traffic density, corresponding traffic situation data can easily be determined. By using the tracking of individual terminals, very good information about the quality of the traffic flow on individual series of roads in the network of traffic routes can be obtained in an extremely simple way in every case. Because of the method, the quality of the data is better that more densely woven the cellular mobile radio network, that is to say the smaller the cell radii.

The accuracy of the location determining function is further enhanced by the fact that, at one location of a mobile terminal, there is frequently simultaneous contact with a plurality of base stations. To this extent, the sequence of the base station identifiers advantageously does not just comprise individual values but often, also corresponding to the number of base stations with which contact is made simultaneously, also pairs of values of two or more identifiers. Of course, this applies both to the characteristic pattern formed and to the currently determined sequences for an individual terminal.

In the following text, the invention will be explained in more detail using the exemplary embodiment illustrated schematically in the single figure.

The drawing shows a detail from a cellular mobile radio network whose individual cells are designated by the designations 1 to 12. The cells are reproduced in an idealized manner as simple circles. In actual fact, the transmission ranges of individual base stations often deviate from the circular shape, however, because of topographical influences. In the details of the mobile radio network, part of a network of traffic routes is also shown, which comprises the two courses of a main road A and a secondary road B branching therefrom. Then, if a vehicle having an operating mobile radio telephone travels along the main road from bottom left to top right, the result as far as the branch of the secondary road B is the following sequence of base station identifiers:

(9), (5,9,10), (5,10), (5), (5,6), (6)

When the vehicle has passed the branch to the secondary road, the result is the following pairs of values for the base station identifiers:

(6,7), (7,4), (4)

However, if the vehicle were to turn into the secondary road B at the branch to the secondary road B, the result would be the following further sequence:

(6,11), (11), (11,12), (12)

From this, it is clearly possible to see that the route traced by an individual terminal can be followed quite reliably by using the base station identifiers. If individual mutually spaced locations, to each of which a pair of values is assigned, are assigned the respective geographic distances actually lying between them and, furthermore, the times are recorded at which these pairs of values are each recorded at the mobile terminal observed, it is simply possible to determine values which are representative of the speed of movement of the respective terminal. Particularly suitable for this purpose are pairs of values which can be recorded on comparatively short portions of the network of traffic routes, that is to say which lie in the boundary area of two or more individual cells. This applies, for example, to the pair of values (5, 9, 10) comprising three individual values and also to the pairs of values comprising two individual values.

The particular advantage of the present invention resides in the fact that comparatively very accurate observation of the traffic flow is made possible without there being any requirement for this purpose for a specific device-technical infrastructure in the vehicles which use the network of traffic routes. The principle is merely evaluation of the base station identifiers which are recorded by the respective terminal in order to keep contact with the respective base station within the context of maintaining the mobile radio function.

1. A method for acquiring traffic situation data in a network of traffic routes which is covered by a cellular mobile radio network having a large number of base stations having a unique identifier, and in which a large number of vehicles move, each being provided with an operating mobile terminal for the mobile radio network, information about the contact between the terminals and the base stations being used to estimate the current location of terminals, characterized
in that, at least for part of the network of traffic routes, in which the base stations have a transmission range with a cell radius which is of the order of magnitude of the distance between adjacent traffic routes to be distinguished from one another, characteristic patterns are determined in the sense of sequences of the identifiers of those base stations with which a terminal respectively makes contact as it moves along a route, are assigned to the respective route and permanently stored,
and in that in order to obtain current traffic situation information for selected terminals, in each case the current sequence of the base stations contacted by this terminal is determined, compared with the stored characteristic patterns and used to decide in which part of the route the respective terminal is presently located.

2. The method as claimed in claim 1, characterized in that it is applied in part of the network of traffic routes in which the cell radius is respectively substantially below 1000 m, in particular below 550 m.

3. The method as claimed in either of claims 1 and 2, characterized in that in the current sequence of the contacted base stations, information about the time of making contact between the respective terminal and the respective base station is recorded and used to determine a value representative of the speed of movement of the respective terminal.

4. The method as claimed in one of claims 1 to 3, wherein the characteristic patterns and current sequences of the base station identifiers for an individual terminal at least partly comprise pairs of values from two or more base stations with which the terminal is in contact at one location.

5. A device system for implementing the method as claimed in one of claims 1 to 5.
The invention relates to a method for acquiring traffic situation data in a network of traffic routes which is covered by a cellular mobile radio network having a large number of base stations having an individual identifier, and in which a large number of vehicles move, each being provided with an operating mobile terminal for the mobile radio network, information about the contact between the terminals and the base stations being used to estimate the current location of terminals. Here, at least for part of the network of traffic routes, in which the base stations have a transmission range with a cell radius which is of the order of magnitude of the distance between adjacent traffic routes to be distinguished from one another, characteristic patterns are determined in the sense of sequences of the identifiers of those base stations with which a terminal respectively makes contact as it moves along a route, are assigned to the respective route and permanently stored.
